(19) United States
(12) Patent Application Publication
(10) Pub. No.: US 2005/0083354 A1
(43) Pub. Date: Apr. 21, 2005

(54) Display apparatus and control method thereof

(75) Inventor: Seung-Jin Oh, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/949,385

(22) Filed: Sep. 27, 2004

(30) Foreign Application Priority Data
Oct. 20, 2003 (KR) 2003-73050

(51) Int. Cl. H04N 1/46; G09G 5/10

(52) U.S. Cl. 345/690

(57) ABSTRACT

A display apparatus for selectively displaying a distinctive image signal of a selected input mode, including: a color temperature detector which detects a circumferential color temperature; a color data memory which stores color data of a proper color sense according to selected input mode and the circumferential color temperature; a color data converter which converts the color data and outputs converted color data; and a controller which controls the color data converter so as to convert the color data of the image signal according to the color data of the color data memory corresponding to the selected input mode and the detected color temperature.

### CROSS-REFERENCE TO RELATED APPLICATION

This application claims the benefit of Korean Patent Application No. 2003-073050, filed Oct. 20, 2003, in the Korean Intellectual Property Office, the disclosure of which is incorporated herein by reference.

### BACKGROUND OF THE INVENTION

1. Field of the Invention

The present invention relates to a display apparatus and a control method thereof, and more particularly, to a display apparatus and a control method thereof providing a proper color sense to a user, regardless of variation of environments and input source.

2. Description of the Related Art

In a general display apparatus, technologies for an automatic control of a displaying status have been developed for the sake of user convenience and to provide a better viewing environment.

Among such technologies, a technology for adjusting white balance of a television is disclosed already.

FIG. 1 is a schematic block diagram of a conventional white balance adjustor of a television. As shown therein, the conventional white balance adjustor comprises a test pattern generator 110 generating a test pattern for a white balance adjustment; a television receiver 120 displaying the test pattern outputted from the test pattern generator 110 and adjusting the white balance in response to high light and low light adjustment signals, a sub-contrast signal, and an automatic brightness limit (ABL) adjustment signal; first and second sensors 130a and 130b respectively installed on a high light area and a low light area of the television receiver 120 and outputting light emission data of the high light and low light areas; a chromatic part 140 outputting a color coordinate and a brightness of the television receiver 120 by analyzing the light emission data outputted from the first and second sensors 130a and 130b; a computer main body 150 recognizing the color coordinate and the brightness of the high light and low light areas outputted from the chromatic part 140 and adjusting the white balance by compensating the light emission data by comparing the color coordinate and the brightness with a predetermined criterion data to make the light emission data on the same level with the criterion data; and a display 160 displaying the criterion data and a compared data in response to a control data of the computer main body and showing an adjustment status.

FIG. 2 illustrates an example of a test pattern for adjusting the white balance. As shown therein, the test pattern for adjusting the white balance comprises a high light adjusting area, a low light adjusting area, and a gray level formed between the high light area and the low light area. A remain area is a black area.

A conventional white balance adjustor with such configuration generates the test pattern formed with the high light adjusting area, the low light adjusting area, and the gray level between the high light and low light areas using the pattern generator 110 and transfers the test pattern to the television receiver 120. Accordingly, the test pattern for adjusting the white balance is displayed on a screen of the television receiver 120.

If the first and second sensors 130a and 130b installed on the high light and low light areas of the television receiver 120 output the light emission data of the high light and low light areas, the chromatic part 140 analyzes the light emission data and transfers the color coordinate and the brightness of the high light and low light areas to the computer main body 150 through an “RS-232C” communication line.

Accordingly, the computer main body 150 outputs the specified criterion data for adjusting a white balance, a sub-contrast, and an ABL and the data of the color coordinate and the brightness transferred from the chromatic part 140 to the display 160 so that a user can monitor and compare both of the criterion data, color coordinate data, and the brightness.

As the user adjusts a difference of both of the displayed data to be relatively small, the computer main body 150 transfers finally adjusted values to the television receiver 120 so that the high light, the sub-contrast, the low light, and the ABL are adjusted with the high light color coordinate, the brightness of the high light area, the low light color coordinate, and the brightness detected in the low light area, respectively. In this way, an adjustment of the white balance is completed.

However, there exists a problem that the adjustment of the white balance using the conventional white balance adjustor is done in a darkroom and a user's color sense is affected by variation of color temperature caused by changes of environment.

Meanwhile, the user's color sense is also affected as an input image source such as a red-green-blue (RGB), or an S-video is switched according to the user's selection.

Accordingly, variation of the user's color sense needs to be minimized regardless of variation of the color temperature and the input source.

### BRIEF SUMMARY

Accordingly, it is an aspect of the present invention to provide a display apparatus and a control method thereof providing a proper color sense to a user, regardless of variation of environments and input source.

According to an aspect of the present invention, there is provided a display apparatus for selectively displaying a distinctive image signal of a selected input mode, including: a color temperature detector which detects a circumferential color temperature; a color data memory which stores color data of a proper color sense according to selected input mode and the circumferential color temperature; a color data converter which converts the color data and outputs converted color data; a controller which controls the color data converter so as to convert the color data of the image signal according to the color data of the color data memory corresponding to the selected input mode and the detected color temperature.

The image signal may be at least one of a component image signal, an RGB image signal, a DVI image signal, an S-video image signal, and a PC image signal.

A circumferential light source which outputs a circumferential color temperature may be one of a candle flame, a tungsten light bulb, a day light, a light bulb, a white fluorescent light bulb, and an average blue sky.

The controller may control the color data converter to convert the color data of the image signal according to the color data closest to the selected input mode and the detected color temperature when the color data corresponding to the selected input mode and the detected color temperature is determined not to be present in the color data memory.

The color data may include at least one of a color coordinate and a color temperature.

According to another aspect of the present invention, there is provided a display apparatus control method of selectively displaying an image signal of an input mode, including: storing color data on a desired color sense according to an input mode and a circumferential color temperature; detecting the circumferential color temperature; and converting the color data of a received image signal according to the color data corresponding to the selected input mode and the detected color temperature.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a schematic block diagram of a conventional white balance adjustor;

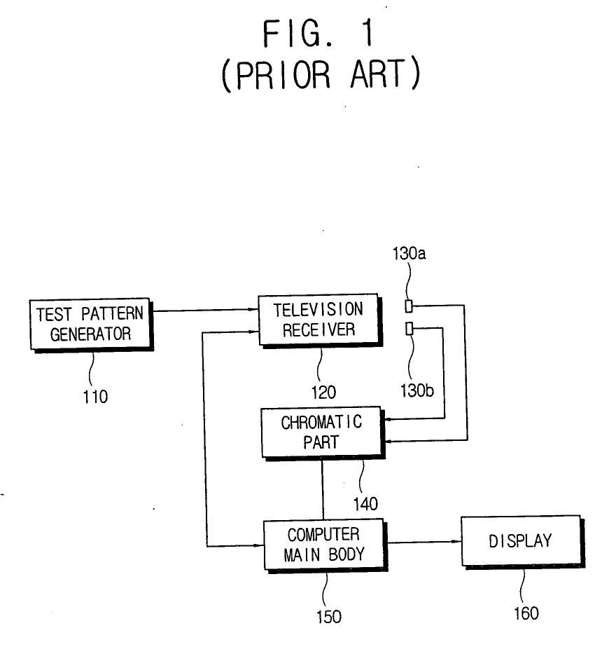

FIG. 2 illustrates a conventional test pattern for adjusting white balance;

FIG. 3 is a control block diagram of a display apparatus according to an embodiment of the present invention;

FIG. 4 is a table showing a part of color data stored in a color data memory in FIG. 3;

FIG. 5 is a control flowchart of the display apparatus of FIG. 3.

### DETAILED DESCRIPTION OF EMBODIMENT

Reference will now be made in detail to embodiments of the present invention, examples of which are illustrated in the accompanying drawings, wherein like reference numerals refer to the like elements throughout. The embodiments are described below in order to explain the present invention by referring to the figures.

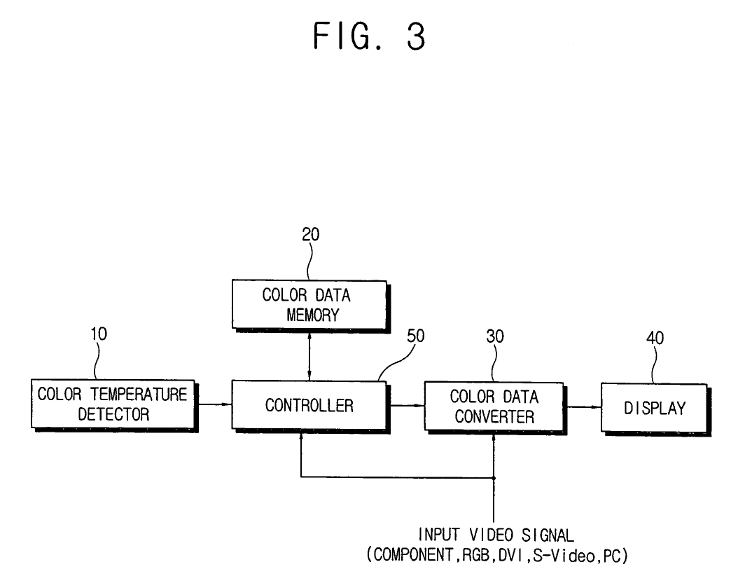

FIG. 3 is a control block diagram of a display device according to an embodiment the present invention. As shown therein, the display device comprises a display 40, a color temperature detector 10 detecting a circumferential color temperature, a color data memory 20 storing color data of a proper color sense according to an input mode and a circumferential color temperature, a color data converter 30 converting the color data of an inputted image signal to output the color data to the display 40, a controller 50 controlling the display device, and a selector (not shown) selecting the input mode of the image signal.

The color temperature detector 10 detects the color temperature according to circumferential lights of the display device, and can be realized by, for example, a sensor sensing wavelengths of the light. The circumferential lights are provided by various sources such as, for example, a candle, a tungsten light bulb, day light, a light bulb, a white fluorescent light, an average blue sky, and the like.

The color data memory 20 is, for example, an electrically erasable programmable read only memory (EEPROM), and stores the color data on the proper color sense according to the input mode and the circumferential color temperature to provide the proper color sense to a user regardless of variation of environment and input source.

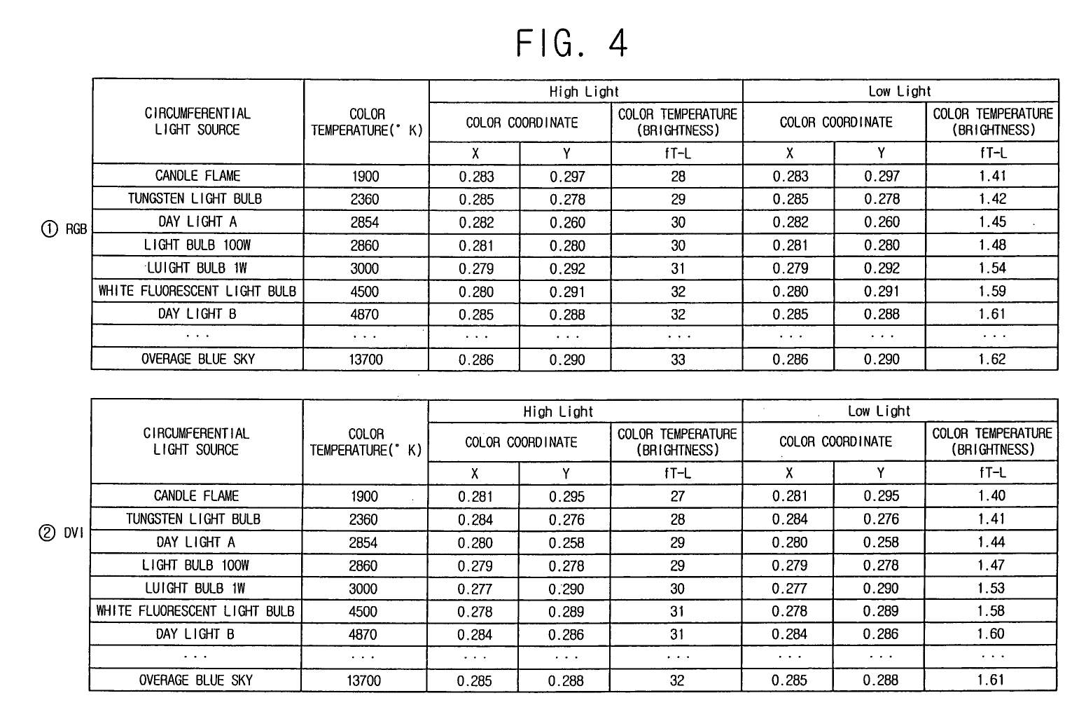

FIG. 4 illustrates an example of color data stored in the color data memory 20. However, it is to be understood figures of the color data illustrated in FIG. 4 are not absolute figures, but arbitrarily set-up figures.

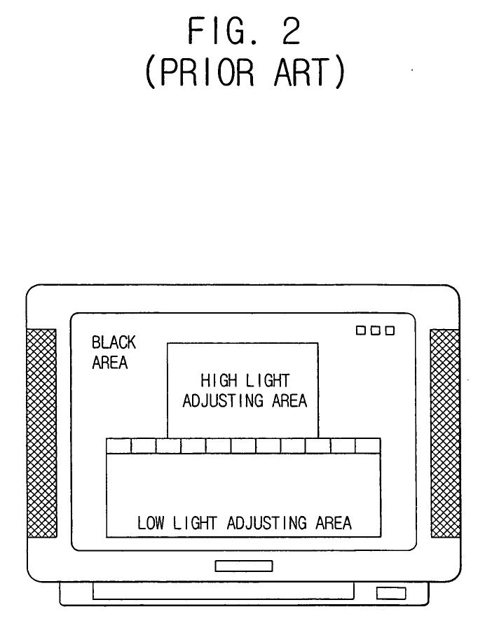

As shown therein, the data of the color coordinate and the color temperature on the high light and low light areas with the test pattern of FIG. 2 are stored, respectively, according to the respective input modes and the color temperature of the circumferential light, and those data are optimized so that the user's color sense is less affected by conversion of the input mode or the variation of the circumferential light.

Although data of red-green-blue (RGB) and digital video interface (DVI) input modes are illustrated in FIG. 4, it is to be understood data of the input mode other than those input modes can be stored as well.

Herein, the high light is adjusted with the high light color coordinate, and the sub-contrast is adjusted with the color temperature of the high light area. Also, the low light is adjusted with the low light color coordinate, and the ABL is adjusted with the color temperature of the low light area.

The color data converter 30 adjusts gain and offset values of the image signal inputted according to a control signal of the controller 50 to convert the color data, and outputs the color data to the display 40.

If the user selects the input mode using the selector, the controller 50 detects the input mode of the image signal. Herein, the input mode of the image signal comprises at least one of a component mode, a RGB mode, a DVI mode, an S-video mode, and a personal computer (PC) mode. The input mode may include additional input modes other than these modes.

Also, the controller 50 decides the circumferential color temperature by receiving a color temperature detection signal from the color temperature detector 10.

The controller 50 reads the data of the color coordinate and the color temperature corresponding to the decided color temperature and the selected input mode from the color data memory 20. If it is determined the data of the corresponding color coordinate and color temperature are not present, data of the color coordinate and the color temperature closest to the decided color temperature and the selected input mode are read. The controller 50 transfers the data of the color coordinate and the color temperature read from the color data memory 20 to the color data converter 30, and controls the color data controller 30 to convert the color data on a basis of the data on the color coordinate and the color temperature received from the controller 50.

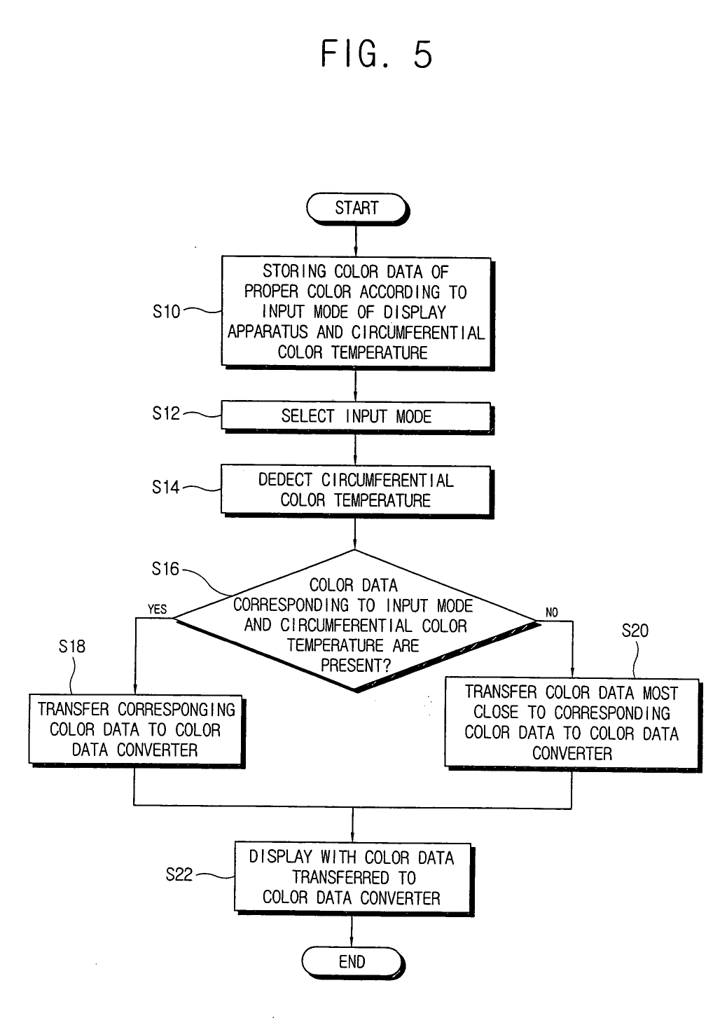

FIG. 5 illustrates a control flowchart of the display device of FIG. 3.

As shown therein, at operation S10, the color data memory 20 stores the color data of a proper color sense according to the input mode and the circumferential color temperature using various circumferential lights relative to all of the input modes of the display apparatus in an assembly line of the display apparatus.

Also, at operation S12, the controller 50 of the display apparatus receives an input mode selection signal selected by the user and detects the inputted input mode. At operation S14, the controller 50 determines the circumferential color temperature on a basis of the detected signal from the color temperature detector 10.

At operation S16, as the input mode is selected and the circumferential color temperature is detected, the controller 50 confirms if the data of the color coordinate and the color temperature corresponding to the selected input mode and the detected circumferential color temperature are present among the color data stored in the color data memory 20. At operation S18, if the data of the corresponding color coordinate and the color temperature are present, the controller 50 sends the data of the corresponding color coordinate and the color temperature to the color data converter 30. At operation S22, the controller 50 controls the color data converter 30 to display a color with the color coordinate and the color temperature received.

Meanwhile, when the controller 50 determines that the data of the color coordinate and the color temperature corresponding to the selected input mode and the detected circumferential color temperature are not present, the controller 50 transfers the data of the color coordinate and the color temperature closest to the selected input mode and the detected circumferential color temperature to the color data converter 30 at operation S20. Also, at operation S22, the controller 50 controls the color data converter 30 to display a color with the color coordinate and the color temperature received.

As described above, the embodiment of the present invention stores the color data of a proper color sense according to an input mode and a circumferential color temperature in the color data memory 20, and controls the color data converter 30 to convert the color data of the image signal inputted according to the color data of the color data memory 20 corresponding to the input mode selected by the user and the circumferential color temperature detected by the color temperature detector 10. Accordingly, the embodiment of the present invention makes the user's color sense less affected by the variation of the input mode and the circumferential color temperature.

As described above, the embodiment of the present invention provides a display apparatus and a control method thereof providing a proper color sense to a user regardless of variation of environment and an input source.

Although an embodiment of the present invention has been shown and described, the present invention is not limited to the described embodiment. Instead, it would be appreciated by those skilled in the art that changes may be made in the embodiment without departing from the principles and spirit of the invention, the scope of which is defined by the claims and their equivalents.

1. A display apparatus for selectively displaying a distinctive image signal of a selected input mode, comprising:
a color temperature detector which detects a circumferential color temperature;
a color data memory which stores color data of a proper color sense according to the selected input mode and the circumferential color temperature;
a color data converter which converts the color data and outputs converted color data; and
a controller which controls the color data converter so as to convert the color data of the image signal according to the color data of the color data memory corresponding to the selected input mode and the detected color temperature.

2. The display apparatus of claim 1, wherein the image signal is at least one of a component image signal, an RGB image signal, a DVI image signal, an S-video image signal, and a PC image signal.

3. The display apparatus of claim 1, wherein a circumferential light source outputs the circumferential color temperature and is one of a candle flame, a tungsten light bulb, a day light, a light bulb, a white fluorescent light bulb, and an average blue sky.

4. The display apparatus of claim 2, wherein a circumferential light source outputs the circumferential color temperature and is one of a candle flame, a tungsten light bulb, a day light, a light bulb, a white fluorescent light bulb, and an average blue sky.

5. The display apparatus of claim 1, wherein the controller controls the color data converter to convert the color data of the image signal input according to the color data closest to the selected input mode and the detected color temperature when the color data corresponding to the selected input mode and the detected color temperature is determined not to be present in the color data memory.

6. The display apparatus according to claim 2, wherein the controller controls the color data converter to convert the color data of the image signal input according to the color data closest to the selected input mode and the detected color temperature when the color data corresponding to the selected input mode and the detected color temperature is determined not to be present in the color data memory.

7. The display apparatus according to claim 1, wherein the color data includes at least one of a color coordinate and a color temperature.

8. The display apparatus according to claim 2, wherein the color data includes at least one of a color coordinate and a color temperature.

9. The display apparatus of claim 1, wherein the color temperature detector is a sensor which senses wavelengths of light.

10. The display apparatus of claim 1, wherein the color data memory is an electrically erasable programmable read only memory (EEPROM).

11. The display apparatus of claim 1, wherein, to convert color data, the color data converter adjusts gain and offset values of the input image signal according to a control signal from the controller.

12. A display apparatus control method of selectively displaying an image signal of an input mode, comprising:
storing color data on a desired color sense according to the input mode and a circumferential color temperature;
detecting the circumferential color temperature; and
converting the color data of a received image signal according to the color data corresponding to the selected input mode and the detected color temperature.

13. The control method of claim 12, wherein the image signal of the input mode is one of a component image signal, an RGB image signal, a DVI image signal, an S-video image signal, and a PC image signal.

14. The control method of claim 12, wherein a circumferential light source with the color temperature comprises one of a candle flame, a tungsten light bulb, a day light, a light bulb, a white fluorescent light bulb, and an average blue sky.

15. The control method of claim 13, wherein a circumferential light source comprises one of a candle flame, a tungsten light bulb, a day light, a light bulb, a white fluorescent light bulb, and an average blue sky.

16. The control method of claim 12, further comprising converting the color data of the image signal input according to the color data closest to the selected input mode and the detected color temperature when the color data corresponding to the selected input mode and the detected color temperature is determined not to be present in the color data memory.

17. The control method of claim 13, further comprising converting the color data of the image signal input according to the color data closest to the selected input mode and the detected color temperature when the color data corresponding to the selected input mode and the detected color temperature is determined not to be present in the color data memory.

18. The control method of claim 12, wherein the color data includes at least one of a color coordinate and a color temperature.

19. The control method of claim 13, wherein the color data includes at least one of a color coordinate and a color temperature.
